(19) United States
(12) Patent Application Publication
(10) Pub. No.: US 2019/0287258 A1
(43) Pub. Date: Sep. 19, 2019

(54) Control Apparatus, Robot System, And Method Of Detecting Object

(71) Applicant: Seiko Epson Corporation, Tokyo (JP)

(72) Inventors: Tomonori MANO, Shiojiri (JP); Masaki HAYASHI, Matsumoto (JP)

(21) Appl. No.: 16/353,022

(22) Filed: Mar. 14, 2019

(30) Foreign Application Priority Data
Mar. 15, 2018 (JP) 2018-047378

(51) Int. Cl. G06T 7/564; G06T 7/593; G06K 9/00; B25J 9/16

(52) U.S. Cl. CPC G06T 7/564; G06T 7/593; G06K 9/00664; G06T 2207/20221; G06T 2207/10028; G06T 2207/10012; B25J 9/1697

(57) ABSTRACT

A control apparatus includes a processor, and includes an image capturing process that is capturing n images by capturing the image of an object using a camera with projecting complementary n projection patterns on the object, a point cloud generation process that is generating a point cloud representing three-dimensional positions of a plurality of pixels of the image using one or more of the n images, a contour detection process that is generating a combined image using the n images and detecting a contour of the object from the combined image, and an object detection execution process that is detecting the object using the point cloud and the contour of the object.

### BACKGROUND

### 1. Technical Field

The present invention relates to an object detection technique using a camera.

### 2. Related Art

In various apparatuses including robots, object detection techniques of detecting three-dimensional objects are used. As one of the object detection techniques, a method of measuring the depth of an object using an image captured by a stereo camera is used.

Patent Document 1 (JP-A-2001-147110) discloses a stereo method with improved three-dimensional measurement accuracy by projecting a pattern on a measuring object and generating texture as a three-dimensional depth measuring method.

However, in the case where measurement of position and attitude of the object with higher accuracy is desired, it is necessary to estimate the position and attitude by combining contour information of a two-dimensional image in addition to the three-dimensional measurement result. In this case, if imaging for three-dimensional measurement and imaging for contour detection are separately executed, there is a problem that a longer time is required until the entire process is completed.

### SUMMARY

According to an aspect of the invention, a control apparatus that executes detection of an object is provided. The control apparatus includes an image capturing part that captures n images by imaging the object using a camera with complementary n projection patterns projected on the object for n which is an integer equal to or larger than two, a point cloud generation part that generates a point cloud representing positions of a plurality of pixels of the image with three-dimensional coordinates using one or more of the n images, a contour detection part that generates a combined image using the n images and detects a contour of the object from the combined image, and an object detection execution part that detects the object using the point cloud and the contour of the object.

### BRIEF DESCRIPTION OF THE DRAWINGS

The invention will be described with reference to the accompanying drawings, wherein like numbers reference like elements.

FIG. 1 is a conceptual diagram of a robot system.

FIG. 2 is a conceptual diagram showing an example of a control apparatus having a plurality of processors.

FIG. 3 is a conceptual diagram showing another example of the control apparatus having a plurality of processors.

FIG. 4 is a block diagram showing functions of the control apparatus.

FIG. 5 is a plan view showing a plurality of parts held in a parts feeder.

FIG. 6 is a flowchart showing a procedure of an object detection process in a first embodiment.

FIG. 7 is an explanatory diagram of the object detection process in the first embodiment.

FIG. 8 is a flowchart showing a procedure of an object detection process in a second embodiment.

FIG. 9 is an explanatory diagram of the object detection process in the second embodiment.

### DESCRIPTION OF EXEMPLARY EMBODIMENTS

### A. First Embodiment

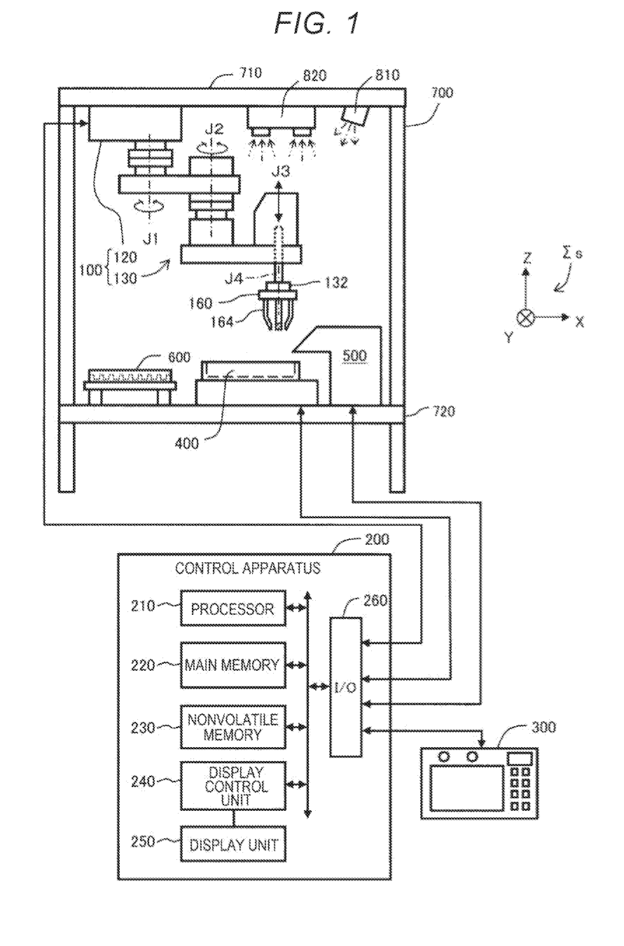

FIG. 1 is a conceptual diagram of a robot system. The robot system is installed on a rack 700 and includes a robot 100, a control apparatus 200 connected to the robot 100, a teaching pendant 300, a parts feeder 400, a hopper 500, a parts tray 600, a projection device 810, and a camera 820. The robot 100 is fixed under a top plate 710 of the rack 700. The parts feeder 400, the hopper 500, and the parts tray 600 are mounted on a table part 720 of the rack 700. The robot 100 is a robot of a teaching playback system. The work using the robot 100 is executed according to teaching data created in advance. In the robot system, a system coordinate system Σs defined by three orthogonal coordinate axes X, Y, Z is set. In the example of FIG. 1, the X-axis and the Y-axis extend in horizontal directions and the Z-axis extends in the vertical upward direction. Taught points contained in teaching data and attitudes of end effectors are represented by coordinate values of the system coordinate system Σs and angles about the respective axes.

The robot 100 includes a base 120 and an arm 130. The arm 130 is sequentially connected by four joints J1 to J4. Of these joints J1 to J4, three joints J1, J2, J4 are twisting joints and one joint J3 is a translational joint. In the embodiment, the four-axis robot is exemplified, however, a robot having an arbitrary arm mechanism with one or more joints can be used.

An end effector 160 is attached to an arm flange 132 provided in the distal end part of the arm 130. In the example of FIG. 1, the end effector 160 is a gripper that grips and lifts a part using a gripping mechanism 164. Note that, as the end effector 160, another mechanism such as a suction pickup mechanism can be attached.

The parts feeder 400 is a container device that contains parts to be gripped by the end effector 160. The parts feeder 400 may be formed to have a vibration mechanism for vibrating parts and distributing the parts. The hopper 500 is a parts supply device that supplies parts to the parts feeder 400. The parts tray 600 is a tray having many recessed portions for individually holding the parts. In the embodiment, the robot 100 executes work of picking up the parts from inside of the parts feeder 400 and placing the parts in appropriate positions within the parts tray 600. Note that the robot system can be applied to execution of other work.

The control apparatus 200 has a processor 210, a main memory 220, a nonvolatile memory 230, a display control unit 240, a display unit 250, and an I/O interface 260. These respective parts are connected via a bus. The processor 210 is e.g. a microprocessor or processor circuit. The control apparatus 200 is connected to the robot 100, the teaching pendant 300, the parts feeder 400, and the hopper 500 via the I/O interface 260. The control apparatus 200 is further connected to the projection device 810 and the camera 820 via the I/O interface 260.

As the configuration of the control apparatus 200, other various configurations than the configuration shown in FIG. 1 may be employed. For example, the processor 210 and the main memory 220 may be removed from the control apparatus 200 in FIG. 1, and the processor 210 and the main memory 220 may be provided in another apparatus communicably connected to the control apparatus 200. In this case, a whole apparatus including the other apparatus and the control apparatus 200 functions as the control apparatus of the robot 100. In another embodiment, the control apparatus 200 may have two or more processors 210. In yet another embodiment, the control apparatus 200 may be realized by a plurality of apparatuses communicably connected to one another. In these various embodiments, the control apparatus 200 is formed as an apparatus or a group of apparatuses including one or more processors 210.

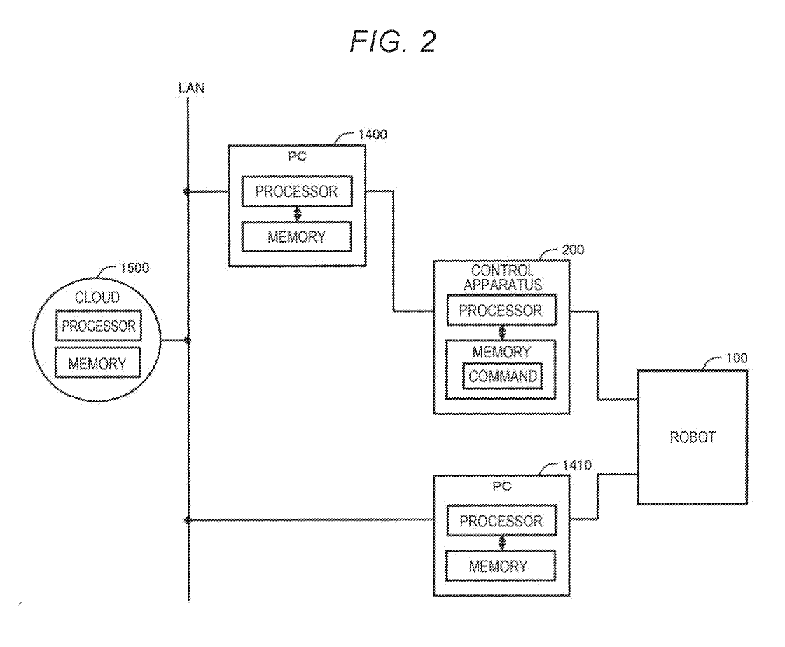

FIG. 2 is a conceptual diagram showing an example of a control apparatus of a robot having a plurality of processors. In the example, in addition to the robot 100 and the control apparatus 200 thereof, personal computers 1400, 1410 and a cloud service 1500 provided via a network environment such as LAN are drawn. Each of the personal computers 1400, 1410 includes a processor and a memory. Also, in the cloud service 1500, a processor and a memory can be used. The control apparatus of the robot 100 can be realized using part or all of the plurality of processors.

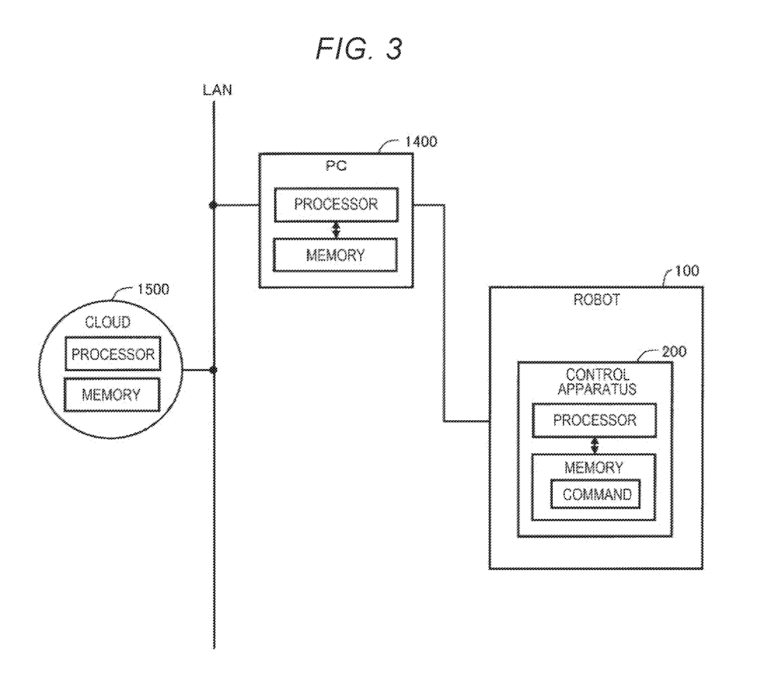

FIG. 3 is a conceptual diagram showing another example of the control apparatus of a robot having a plurality of processors. In the example, the control apparatus 200 of the robot 100 is different from that in FIG. 2 in that the control apparatus is housed in the robot 100. Also, in the example, the control apparatus of the robot 100 can be realized using part or all of the plurality of processors.

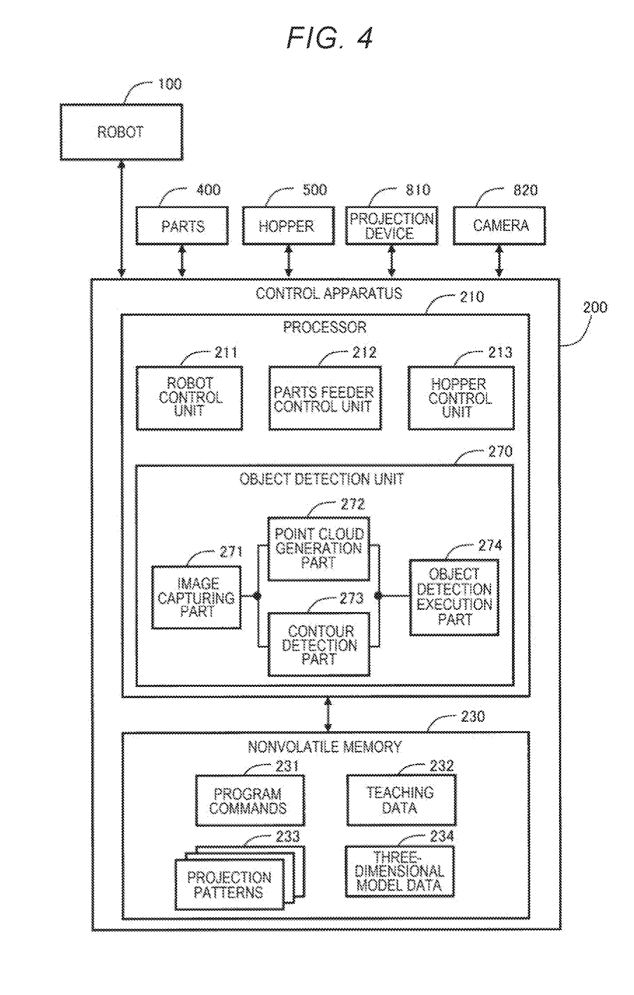

FIG. 4 is a block diagram showing functions of the control apparatus 200. The processor 210 of the control apparatus 200 executes various program commands 231 stored in the nonvolatile memory 230 in advance, and thereby, respectively realizes the functions of a robot control unit 211, a parts feeder control unit 212, a hopper control unit 213, and an object detection unit 270.

The object detection unit 270 includes an image capturing part 271 that captures an image using the camera 820, a point cloud generation part 272 that generates a point cloud using the image, a contour detection part 273 that detects a contour of an object within the image, and an object detection execution part 274 that detects the object using the generated point cloud and the contour. The functions of these respective parts will be described later.

The nonvolatile memory 230 stores various projection patterns 233 to be used for capturing of the images and three-dimensional model data 234 of object to be used for object detection in addition to the program commands 231 and teaching data 232.

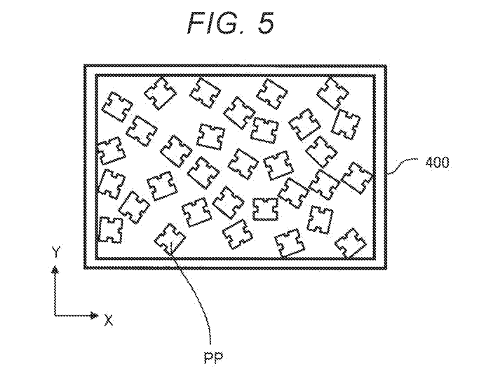

FIG. 5 is a plan view showing a plurality of parts PP held in the parts feeder 400. In the embodiment, an object detection process of imaging the plurality of the same parts PP with the camera 820 and detecting the parts PP by analyzing the image is executed. The detected parts PP can be gripped by the end effector 160. Hereinafter, the parts PP are also referred to as “objects PP”. Note that the object detection process may be used for other purposes than the robot.

In the first embodiment, the camera 820 is a stereo camera. The projection device 810 is provided for projecting a specific projection pattern when the parts PP are imaged using the camera 820. Examples of the projection patterns will be described later.

For the object detection process of the embodiment, the point cloud and contour obtained from the image are used. “Point cloud” refers to a collection of point data of the positions of the pixels of the image represented by the three-dimensional coordinate values X [mm], Y [mm], Z [mm]. As the three-dimensional coordinate system, an arbitrary coordinate system including a camera coordinate system, the system coordinate system Σs, and a robot coordinate system may be used.

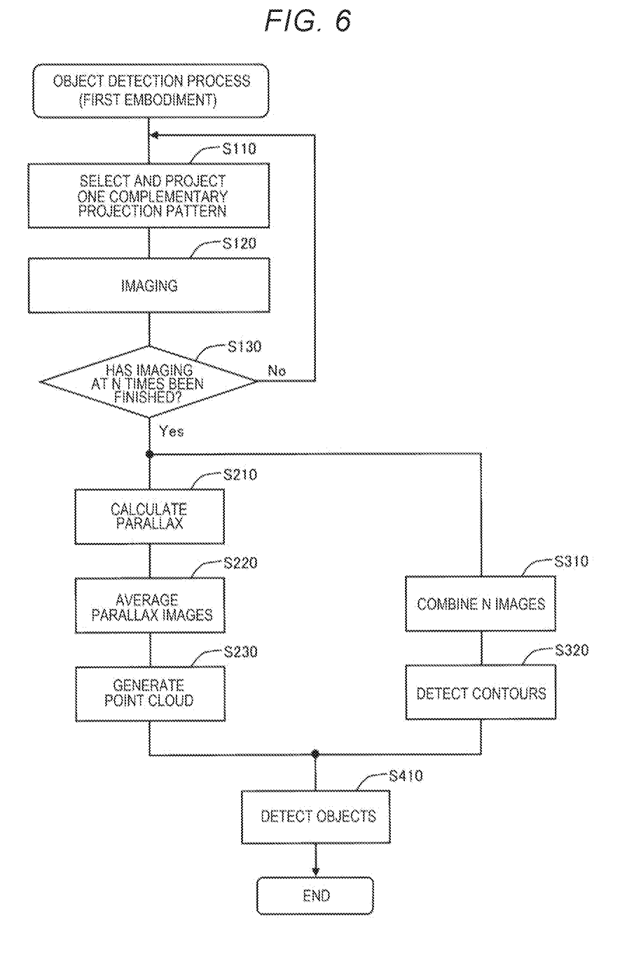

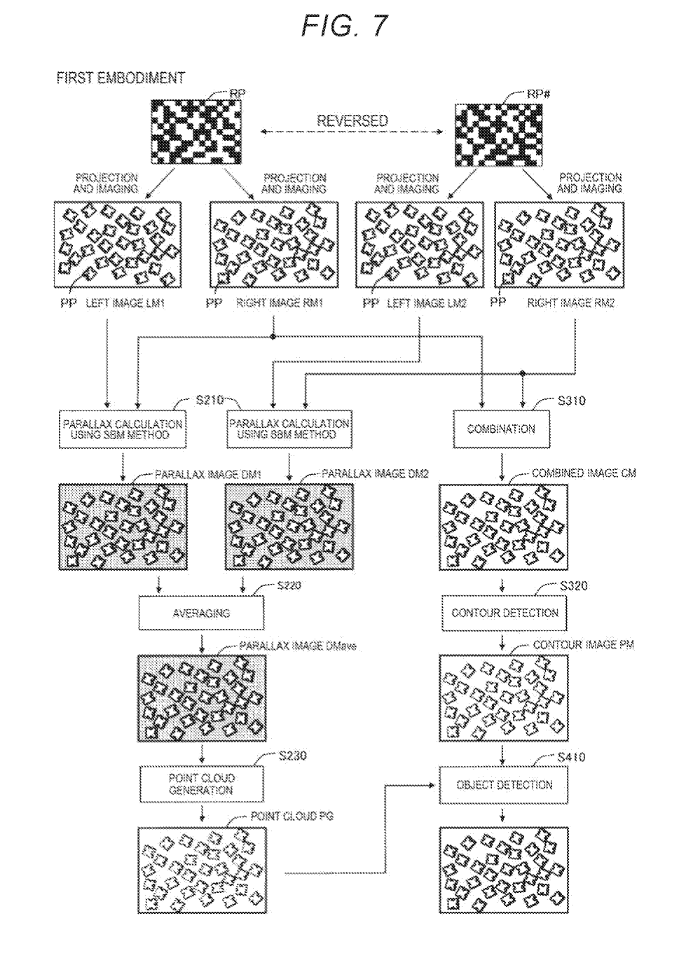

FIG. 6 is a flowchart of the object detection process in the first embodiment, and FIG. 7 is an explanatory diagram thereof. In the first embodiment, a stereo block matching method is used for the point cloud generation process. Steps S110 to S130 in FIG. 6 are executed by the image capturing part 271, steps S210 to S230 are executed by the point cloud generation part 272, steps S310 to S320 are executed by the contour detection part 273, and step S410 is executed by the object detection execution part 274.

At step S110, one of n complementary projection patterns is selected and projected on objects, and, at step S120, an image is captured using the camera 820. Here, n is an integer equal to or larger than two.

As shown in FIG. 7, in the first embodiment, as the n complementary projection patterns, a random dot pattern RP and a reversal pattern RP# thereof are used. The random dot patterns RP, RP# are projected, and thereby, texture may be provided to the surfaces of the parts PP and there is an advantage that the point cloud of the parts PP may be captured with higher accuracy. In FIG. 7, for convenience of illustration, the pixels of the random dot patterns RP, RP# are drawn relatively largely, however, actually, the random dot patterns RP, RP# are formed by pixels sufficiently smaller than the sizes of the parts PP.

In the specification, “n complementary projection patterns” refer to n projection patterns having pixel values to form a uniform image by addition with respect to each pixel in the projection device 810. For example, when the random dot pattern RP and the reversal pattern RP# shown in FIG. 7 are formed as binary images, the pixel values of the patterns are added with respect to each pixel, and thereby, all pixel values become one and form a uniform image. In the example, n is equal to two, but n may be set to three or more. For example, three or more random dot patterns can be formed as complementary projection patterns. As the complementary projection patterns, not limited to the random dot patterns, but other arbitrary projection patterns can be used.

In the first imaging at steps S110, S120, with the random dot pattern RP projected on the parts PP, a left image LM1 and a right image RM1 as stereo images are obtained. At step S130, whether or not imaging at n times has been finished is determined and, if the imaging has not been finished, steps S110, S120 are repeated. In the first embodiment, n=2 and, at the second imaging, with the reversal pattern RP# projected on the parts PP, a left image LM2 and a right image RM2 as stereo images are obtained.

At step S210, a parallax image is generated by calculation of parallax according to the stereo block matching method using one or more sets of the n sets of stereo images obtained by imaging at n times. In the example of FIG. 7, two parallax images DM1, DM2 are generated using the two stereo images. Note that only one parallax image may be generated using one stereo image.

The respective parallax images DM1, DM2 are images that have pixel values representing horizontal parallax of the stereo camera 820. The relationship between parallax D and a distance Z to the stereo camera 820 is given by the following expression:

Z=f×T/D (1)

where f is a focal length of the camera, and T is a distance between optical axes of two cameras forming the stereo camera 820.

Note that preprocesses may be performed on the left image and the right image before the parallax calculation by the stereo block matching method. As the preprocesses, e.g. distortion correction of correcting distortion of the image due to lenses and geometrical correction including a parallelizing process of parallelizing the orientations of the left image and the right image are performed.

At step S220, the two parallax images DM1, DM2 are averaged, and thereby, an averaged parallax image DMave is generated. Note that, when only one parallax image is generated at step S210, step S220 is omitted. Here, the two parallax images DM1, DM2 are averaged, however, values including surrounding pixels may be averaged, or another process for reducing variations of the parallax images DM1, DM2 to improve the accuracy by deletion of abnormal values of the parallax images DM1, DM2 or the like may be performed.

At step S230, then, a point cloud PG is generated from the parallax image DMave. In this regard, the distance Z calculated according to the expression (1) from the parallax D of the parallax image DMave is used. As described above, “point cloud” is the collection of point data of the positions of the pixels of the image represented by the three-dimensional coordinate values X [mm], Y [mm], Z [mm]. Note that the point cloud generation process using the parallax D of the parallax image DMave or the distance Z is well known, and the explanation thereof is omitted here.

At step S310, the n images obtained by imaging at n times are combined, and thereby, a combined image CM is generated. In the example of FIG. 7, the combined image CM is generated by combination of right images RM1, RM2 of the stereo images. In this regard, it is preferable to create the combined image CM using images used as reference images for creation of the parallax images DM1, DM2 of the left images and the right images. This is because the point cloud PG obtained from the parallax images DM and the contour detected from the combined image CM match more closely. Note that the combined image CM may be created using both the left images and the right images. The combination of the images is executed by add operation of adding the pixel values of the corresponding pixels.

At step S320, the contour detection process is executed on the combined image CM, and thereby, a contour image PM is generated. The contour image PM is an image containing the contours of the parts PP. The combined image CM is the image formed by combination of the n images obtained by imaging at n times and little affected by the n complementary projection patterns. Therefore, the contours of the parts PP may be accurately obtained from the combined image CM.

At step S410, the object detection execution part 274 detects the three-dimensional shapes of the parts PP as objects using the point cloud PG and the contours of the contour image PM.

As the method of detecting the three-dimensional shapes of the objects using the point cloud and the contours, e.g. the method described in JP-A-2017-182274 disclosed by the applicant of this application can be used. Or, the method described in “Model Globally, Match Locally: Efficient and Robust 3D Object Recognition”, Bertram Drost et al., http://campar.in.tum.de/pub/drost2010CVPR/drost2010CVPR.pd f, the method described in “Bekutoru Pea Mattingu niyoru Kousinraina Sanjigen Ichi Shisei Ninsiki”, Shuichi Akizuki, http://isl.sist.chukyo-u.ac.jp/Archives/vpm.pdf, or the like may be used. These methods are object detection methods using the point cloud, the contours, and the three-dimensional model data of the objects. Note that the three-dimensional shapes of the objects may be detected from the point cloud and the contours without using the three-dimensional model data.

The detection result of the parts PP as the objects is provided from the object detection unit 270 to the robot control unit 211. As a result, the robot control unit 211 can execute the gripping operation of the parts PP using the detection result.

As described above, in the first embodiment, the point cloud generation and the object contour detection are performed using the n images captured with the complementary n projection patterns projected, and thereby, compared to the case where imaging for point cloud generation for three-dimensional measurement and imaging for object contour detection are separately performed, the time required for the entire process can be shortened.

Further, in the first embodiment, the point cloud generation and the object contour detection are performed using the two sets of stereo images captured with the random dot pattern RP and the reversal pattern RP# thereof projected, and thereby, compared to the case where imaging for point cloud generation for three-dimensional measurement and imaging for object contour detection are separately performed, the time required for the entire process can be shortened.

### B. Second Embodiment

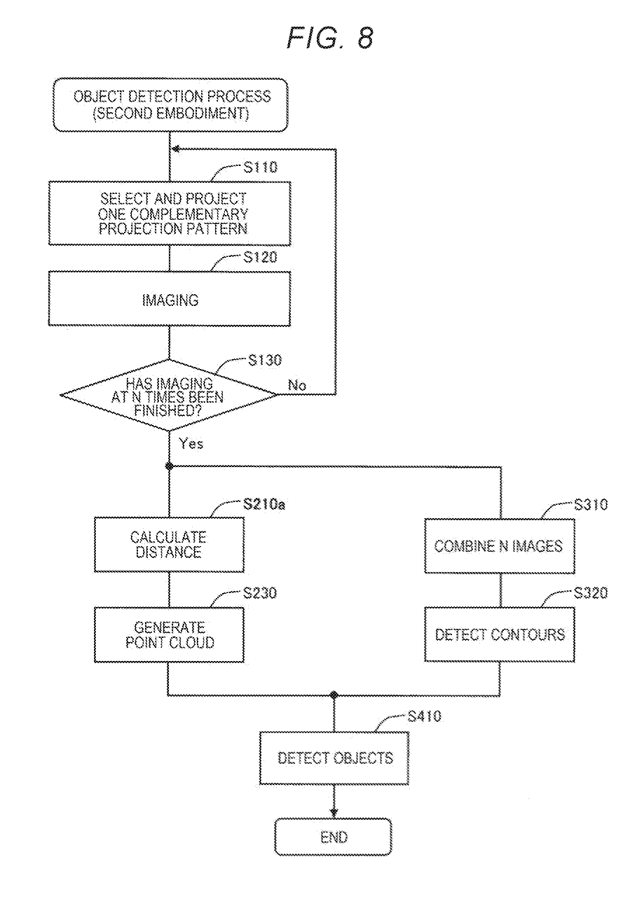

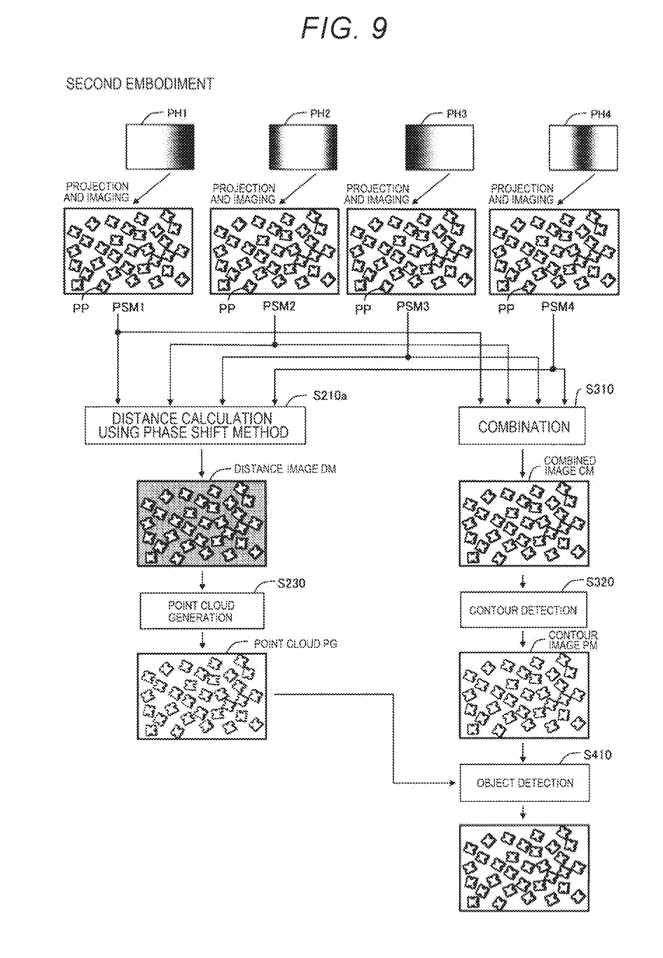

FIG. 8 is a flowchart of an object detection process in the second embodiment, and FIG. 9 is an explanatory diagram thereof. The procedure in FIG. 8 is formed by replacement of step S210 in the procedure of the first embodiment shown in FIG. 6 by step S210a and omission of step S220. In the second embodiment, the phase shift method is used for the point cloud generation process, and phase shift patterns are used as the n projection patterns for imaging at steps S110, S120.

The n phase shift patterns PH1 to PHn shown in FIG. 9 are sinusoidal banded patterns having dark and light parts. In the phase shift method, generally, capturing of images is performed using the n phase shift patterns PH1 to PHn for n which is an integer equal to or larger than three. The n phase shift patterns PH1 to PHn are sinusoidal patterns having phase sequentially shifted by 2π/n. In the example of FIG. 9, n=4. Note that, in the phase shift method, it is not necessary to use the stereo camera, and a monocular camera can be used as the camera 820. Or, only one of the two cameras forming the stereo camera may be used for imaging.

In the second embodiment, four phase shift images PSM1 to PSM4 are obtained at steps 110 to S130. At step S210a, and a distance image DM is generated using these phase shift images PSM1 to PSM4 according to the phase shift method. The generation process of the distance image DM using the phase shift method is well known, and the explanation thereof is omitted here. At step S230, the point cloud PG is generated using the distance image DM.

At step S310, the n images obtained by imaging at n times are combined, and thereby, a combined image CM is generated. In the example of FIG. 9, the combined image CM is generated by combination of the four phase shift images PSM1 to PSM4. The contour detection process at step S320 and the object detection process at step S410 are the same as those of the first embodiment.

As described above, also, in the second embodiment, the point cloud generation and the object contour detection are performed using the n images captured with the complementary n projection patterns projected, and thereby, compared to the case where imaging for point cloud generation for three-dimensional measurement and imaging for object contour detection are separately performed, the time required for the entire process can be shortened.

Further, in the second embodiment, the point cloud generation and the object contour detection are performed using the n images captured with the n phase shift patterns projected on the objects, and thereby, compared to the case where imaging for point cloud generation for three-dimensional measurement and imaging for object contour detection are separately performed, the time required for the entire process can be shortened.

### C. Other Embodiments

The invention is not limited to the above described embodiments, but may be realized in various aspects without departing from the scope of the invention. For example, the invention can be realized in the following aspects. The technical features in the above described embodiments corresponding to the technical features in the following respective aspects can be appropriately replaced or combined for solving part or all of the problems of the invention or achieving part or all of the advantages of the invention. Further, if the technical features are not described as essential features in the specification, the features can be appropriately eliminated.

(1) According to a first aspect of the invention, a control apparatus that executes detection of an object is provided. The control apparatus includes an image capturing part that captures n images by imaging the object using a camera with complementary n projection patterns projected on the object for n which is an integer equal to or larger than two, a point cloud generation part that generates a point cloud representing positions of a plurality of pixels of the image with three-dimensional coordinates using one or more of the n images, a contour detection part that generates a combined image using the n images and detects a contour of the object from the combined image, and an object detection execution part that detects the object using the point cloud and the contour of the object.

According to the control apparatus, the point cloud generation and the object contour detection are performed using the n images captured with the complementary n projection patterns projected, and thereby, compared to the case where imaging for point cloud generation for three-dimensional measurement and imaging for object contour detection are separately performed, the time required for the entire process can be shortened.

(2) In the control apparatus, the n may be two, the n projection patterns may be a random dot pattern and a reversal pattern thereof, and the camera may be a stereo camera.

According to the control apparatus, the point cloud generation and the object contour detection are performed using the two sets of stereo images captured with the random dot pattern and the reversal pattern thereof projected, and thereby, compared to the case where imaging for point cloud generation for three-dimensional measurement and imaging for object contour detection are separately performed, the time required for the entire process can be shortened.

(3) In the control apparatus, the n may be equal to or larger than three, and the n projection patterns may be phase shift patterns formed by sequential shift of phase of sinusoidal patterns by 2π/n.

According to the control apparatus, the point cloud generation and the object contour detection are performed using the n images captured with the n phase shift patterns projected on the object, and thereby, compared to the case where imaging for point cloud generation for three-dimensional measurement and imaging for object contour detection are separately performed, the time required for the entire process can be shortened.

(4) According to a second aspect of the invention, a control apparatus that executes detection of an object is provided. The control apparatus includes a processor, and the processor executes an image capturing process of capturing n images by imaging the object using a camera with complementary n projection patterns projected on the object for n which is an integer equal to or larger than two, a point cloud generation process of generating a point cloud representing positions of a plurality of pixels of the image with three-dimensional coordinates using one or more of the n images, a contour detection process of generating a combined image using the n images and detecting a contour of the object from the combined image, and an object detection execution process of detecting the object using the point cloud and the contour of the object.

According to the control apparatus, the point cloud generation and the object contour detection are performed using the n images captured with the complementary n projection patterns projected, and thereby, compared to the case where imaging for point cloud generation for three-dimensional measurement and imaging for object contour detection are separately performed, the time required for the entire process can be shortened.

(5) According to a third aspect of the invention, a robot connected to the control apparatus is provided.

According to the robot, the detection of the object to be processed by the robot can be performed in a shorter time.

(6) According to a fourth aspect of the invention, a robot system including a robot and the control apparatus connected to the robot is provided.

According to the robot system, the detection of the object to be processed by the robot can be performed in a shorter time.

(7) According to a fifth aspect of the invention, a method of executing detection of an object is provided. The method includes capturing n images by imaging the object using a camera with complementary n projection patterns projected on the object for n which is an integer equal to or larger than two, generating a point cloud representing positions of a plurality of pixels of the image with three-dimensional coordinates using one or more of the n images, generating a combined image using the n images and detecting a contour of the object from the combined image, and detecting the object using the point cloud and the contour of the object.

According to the method, the point cloud generation and the object contour detection are performed using the n images captured with the complementary n projection patterns projected, and thereby, compared to the case where imaging for point cloud generation for three-dimensional measurement and imaging for object contour detection are separately performed, the time required for the entire process can be shortened.

The entire disclosure of Japanese Patent Application No. 2018-047378, filed Mar. 15, 2018 is expressly incorporated by reference herein.

What is claimed is:

1. A control apparatus that executes detection of an object, comprising a processor,
wherein the processor is configured to execute:
an image capturing process that is acquiring n images by capturing an image of the object using a camera with projecting complementary n projection patterns on the object for n which is an integer equal to or larger than two,
a point cloud generation process that is generating a point cloud representing three-dimensional positions which correspond to a plurality of pixels of the image using one or more of the n images,
a contour detection process that is generating a combined image using the n images and detecting a contour of the object from the combined image, and
an object detection execution process that is detecting the object using the point cloud and the contour of the object.

2. The control apparatus according to claim 1, wherein the n is two and the n projection patterns are a random dot pattern and a reversal pattern thereof, and
the camera is a stereo camera.

3. The control apparatus according to claim 1, wherein the n is equal to or larger than three, and
the n projection patterns are phase shift patterns formed by shifting a phase of sinusoidal patterns sequentially by 2π/n.

4. A robot system comprising:
a robot; and
a control apparatus that controls the robot,
the control apparatus including a processor,
wherein the processor is configured to execute:
an image capturing process that is acquiring n images by capturing the image of the object using a camera with projecting complementary n projection patterns on the object for n which is an integer equal to or larger than two,
a point cloud generation process that is generating a point cloud representing three-dimensional positions of a plurality of pixels of the image using one or more of the n images,
a contour detection process that is generating a combined image using the n images and detecting a contour of the object from the combined image, and
an object detection execution process that is detecting the object using the point cloud and the contour of the object.

5. The robot system according to claim 4, wherein the n is two and the n projection patterns are a random dot pattern and a reversal pattern thereof, and
the camera is a stereo camera.

6. The robot system according to claim 4, wherein the n is equal to or larger than three, and
the n projection patterns are phase shift patterns formed by shifting the phase of sinusoidal patterns sequentially by 2π/n.

7. A method of executing detection of an object, comprising:
Acquiring n images by capturing an image of the object using a camera with projecting complementary n projection patterns on the object for n which is an integer equal to or larger than two;
generating a point cloud representing three-dimensional positions of a plurality of pixels of the image using one or more of the n images;
generating a combined image using the n images and detecting a contour of the object from the combined image; and
detecting the object using the point cloud and the contour of the object.

8. The method according to claim 7, wherein the n is two and the n projection patterns are a random dot pattern and a reversal pattern thereof, and
the camera is a stereo camera.

9. The method according to claim 7, wherein the n is equal to or larger than three, and
the n projection patterns are phase shift patterns formed by shifting the phase of sinusoidal patterns sequentially by 2π/n.
